(19) United States
(12) Patent Application Publication
(10) Pub. No.: US 2017/0185224 A1
(43) Pub. Date: Jun. 29, 2017

(54) TOUCHSCREEN DEVICE

(71) Applicant: Sharp Kabushiki Kaisha, Sakai City, Osaka (JP)

(72) Inventors: Kosuke NAGATA, Sakai City (JP); Masayuki HATA, Sakai City (JP)

(21) Appl. No.: 15/312,742

(22) PCT Filed: May 21, 2015
(86) PCT No.: PCT/JP2015/064580

§ 371 Date: Nov. 21, 2016

(30) Foreign Application Priority Data
May 28, 2014 (JP) 2014-110128

(51) Int. Cl. G06F 3/041; G02F 1/1343; G02F 1/1333; G06F 3/044

(52) U.S. Cl. CPC G06F 3/0418; G06F 3/044; G02F 1/134336; G02F 1/13439; G02F 1/13338

(57) ABSTRACT

A touchscreen device includes a touch surface, electrode pairs, a voltage applying portion, an output detecting portion, a correcting portion, and a specifying portion. The electrode pairs include a regular electrode pair and an irregular electrode pair. The voltage applying portion applies a driving voltage to the electrode pairs. The output detecting portion detects outputs from the regular electrode pair and the irregular electrode pair in response to the driving voltage. The correcting portion corrects the output from the irregular electrode pair to amplify the output from the irregular electrode pair to the same level as the output from the regular electrode pair. The specifying portion specifies the electrode pair having the capacitance that is defined as varied based on the output from the regular electrode pair and the output from the irregular electrode pair.

### TECHNICAL FIELD

The present invention relates to a touchscreen device.

### BACKGROUND ART

Capacitive type touchscreen devices have been used as input devices of various display devices in recent years. The touchscreen devices of this kink have touch surfaces for detecting touching operations with fingertips or other operating objects. The touch surfaces are included in display surfaces of the display devices. First electrodes and second electrodes are arranged to cross one another below the touch surfaces. Positions of fingertips that have contacted or been approaching the touch surfaces are detected base on variations in capacitance formed between the first electrodes and the respective second electrodes.

For example, as described in Patent Document 1, first electrodes and second electrodes among which capacitance are formed have patterns similar to each other. The patterns include diamond portions in the same size regularly arranged in lines and connected. The pattern of the first electrodes and the pattern of the second electrodes are arranged to cross each other and overlap the touch surface.

### RELATED ART DOCUMENT

### Patent Document

Patent Document 1: Japanese Unexamined Patent Application Publication No. 2012-150782

### Problem to be Solved by the Invention

The touch surface may include an outer edge portion in which the electrodes cannot be arranged (a dead space). To reduce such a portion, the diamond portions of the electrode at an end may be shaped in a smaller size along the outer edge of the touch surface.

A capacitance formed between each shaped electrode and the corresponding shaped electrode is smaller than the capacitance formed between other electrodes having the regular shape. Therefore, detection accuracy in the edge portion of the touch surface may decrease.

### DISCLOSURE OF THE PRESENT INVENTION

The technology disclosed in this description was made in view of the above circumstances. An object is to provide a capacitive type touchscreen device in which detection accuracy on a touch surface is less likely to decrease.

### Means for Solving the Problem

A touchscreen device according to the present invention includes a touch surface, electrode pairs, a regular electrode pair, an irregular electrode pair, a voltage applying portion, an output detecting portion, a correcting portion, and a specifying portion. An operating object such as a fingertip touches or approaches the touch surface. The electrode pairs include electrodes arrange in a matrix behind the touch surface and opposed to one another with gaps to form capacitances that vary at least when the operating object touches portions of the touch surface corresponding to the electrode pairs. The electrode pairs include a regular electrode pair including opposed portions having a specified length and a irregular electrode pair including opposed portions having a length smaller than the length of the opposed portions of the regular electrode pair. The irregular electrode pair forms a capacitance smaller than a capacitance formed in the regular electrode pair. The voltage applying portion is for applying a driving voltage to the electrode pairs. The output detecting portion is for detecting outputs from the electrode pairs in response to the driving voltage. The correcting portion is for correcting an output from the irregular electrode pair among the outputs from the electrode pairs to amplify the output from the irregular electrode pair to the same level as the output from the regular electrode pair. The specifying portion is for specifying the electrode pair having the capacitance that is defined as varied based on the output from the regular electrode pair and the output from the irregular electrode pair which is corrected.

In the touchscreen device, the correcting portion corrects the output from the irregular electrode pair including the opposed portions with the length smaller than the length of the opposed portions of the regular electrode pair and having the capacitance smaller than the regular electrode pair among the electrode pairs arranged in a matrix behind the touch surface to amplify the output to the same level as the output from the regular electrode pair. Therefore, the electrode pair, the capacitance of which has varied, is specified based on the output from the regular electrode pair and the output from the irregular electrode pair which is corrected. Namely, a decrease in detection accuracy on the touch surface is less likely to occur even though the irregular electrode pair having the capacitance smaller than the capacitance of the regular electrode pair is included.

In the touchscreen device, the irregular electrode pair may have a shape along an outline of the touch surface and may be arranged along the outline of the touch surface. According to the configuration, the irregular electrode pair can be arranged along the outline of the touch surface and thus the touch surface is less likely to include an outer edge portion in which an electrode pair is not arranged (a dead space). Therefore, a decrease in detection accuracy in an outer edge area of the touch surface is less likely to occur.

In the touchscreen device, the correcting portion may correct the output from the irregular electrode pair using a ratio between the length L1 of the opposed portions of the regular electrode pair and the length L2 of the opposed portions of the irregular electrode pair. According to the configuration, a complicated calculation is not required and the output from the irregular electrode pair can be easily corrected.

In the touchscreen device, the correcting portion may multiply the output from the irregular electrode pair by a correction factor of L1/L2. According to the configuration, a complicated calculation is not required and the output from the irregular electrode pair can be easily corrected using the correction factor.

The touchscreen device may further include first electrodes and second electrodes. The first electrodes may include lines of first unit electrodes having an island shape. The first unit electrodes in each line may be linearly arranged and connected via first links. The lines of first unit electrodes may be arranged parallel to each other. The second electrodes may include lines of the second unit electrodes having an island shape. The second unit electrodes in each line may be linearly arranged and connected via second links. The lines of second unit electrodes may be arranged such that the second unit electrodes do not overlap the first unit electrodes and the second links cross the first links with gaps. The electrode pairs may be formed at intersections of the first unit electrodes and the second unit electrodes, respectively. According to the configuration, the electrode pairs can be easily arranged in a matrix behind the touch surface. Therefore, the outputs from the electrode pairs can be easily obtained and easily and properly processed.

In the touchscreen device, the first unit electrodes may include first regular unit electrodes having a regular shape and first irregular unit electrodes having shapes as if portions of the first regular unit electrodes are cut off. The second unit electrodes may include second irregular unit electrodes having irregular shapes as if portions of the second regular electrodes are cut off. The regular electrode pair may include the first regular unit electrodes and the second regular unit electrodes. The irregular electrode pair may include the first irregular unit electrodes and the second irregular unit electrodes.

In the touchscreen device, the first regular unit electrodes and the second regular unit electrodes may have diamond shapes.

The touchscreen device may further include third electrodes and forth electrodes. The third electrodes may include lines of third unit electrodes having an island shape. The third unit electrodes in each line may be linearly arranged and connected via third links. The lines of third unit electrodes may be arranged parallel to each other. The fourth electrodes may include fourth unit electrodes having an island shape and arranged in lines with gaps. Lines of the fourth unit electrodes may be arranged parallel to the third electrodes such that each of the fourth unit electrodes is opposed to the corresponding third unit electrode with a gap. The electrode pairs may include portions of the third unit electrodes and the fourth unit electrodes opposed to one another. According to the configuration, the electrode pairs can be easily arranged in a matrix behind the touch surface. Therefore, the outputs from the electrode pairs can be easily obtained and easily and properly processed.

### Advantageous Effect of the Invention

According to the present invention, a capacitive touchscreen device in which a decrease in detection accuracy on a touch surface is less likely to occur can be provided.

### BRIEF DESCRIPTION OF THE DRAWINGS

FIG. 1 is a plan view schematically illustrating a liquid crystal display device according to a first embodiment of the present invention.

FIG. 2 is a cross-sectional view illustrating a schematic configuration of the liquid crystal display device.

FIG. 3 is a plan view schematically illustrating a panel body.

FIG. 4 is a schematic diagram illustrating connections of first electrodes with first lines.

FIG. 5 is a block diagram of a touchscreen device.

FIG. 6 is a magnified view of the first electrodes and second electrodes disposed in an outer edge area of a touch surface.

FIG. 7 is a graph illustrating a relationship between a capacitance in a regular senor portion and capacitances in an irregular sensor before and after correction.

FIG. 8 is a schematic plan view illustrating a panel body according to a second embodiment.

FIG. 9 is a magnified view of first electrodes and second electrodes disposed in an outer edge area of a touch surface of the second embodiment.

### MODE FOR CARRYING OUT THE INVENTION

### First Embodiment

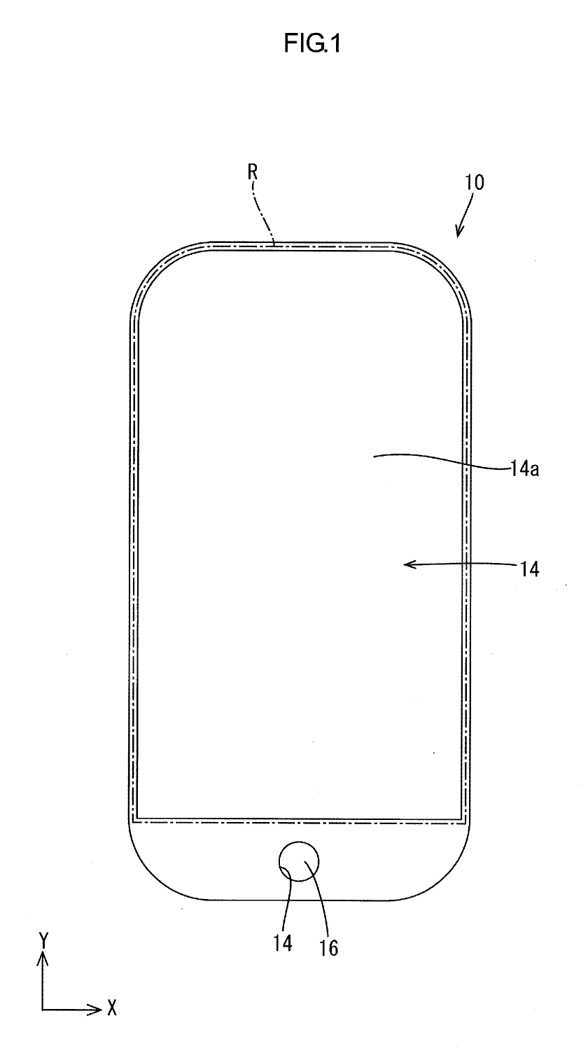

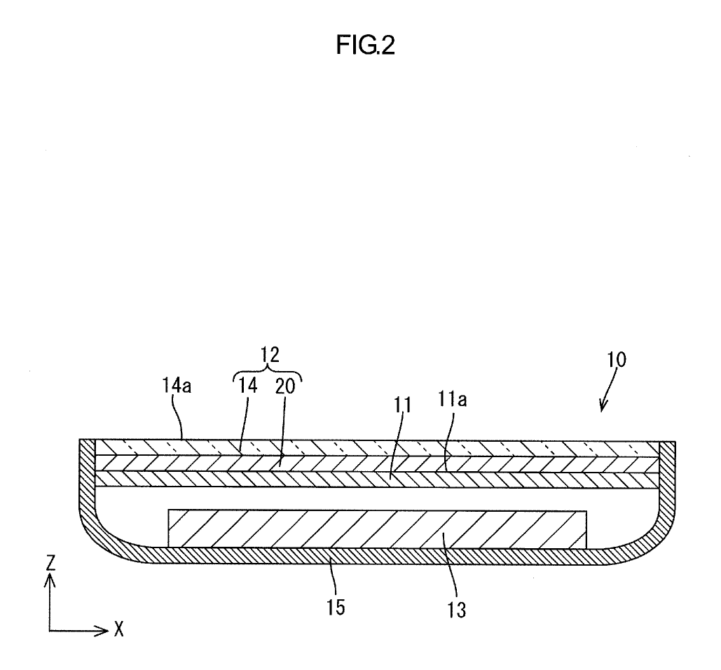

A first embodiment according to the present invention will be described with reference to FIGS. 1 to 7. In this embodiment section, a touchscreen device 12 included in a liquid crystal display device 10 will be described. X-axes, Y-axes, and Z-axes may be present in the drawings. The axes in each drawing correspond to the respective axes in other drawings. The vertical direction is defined based on FIG. 2. An upper side in FIG. 2 is defined as “a front side.” A lower side in FIG. 2 is defined as “a rear side.”

First, a configuration of the liquid crystal display device 10 will be described. As illustrated in FIGS. 1 and 2, the liquid crystal display device 10 has a vertically long rectangular shape with round corners. The liquid crystal display device 10 mainly includes a liquid crystal panel (a display panel) 11, a touchscreen device 12, and a backlight device (a lighting device) 13. The liquid crystal panel 11 is for displaying images. The touchscreen device 12 is for inputting information on in-plane positions on a display surface 11a of the liquid crystal panel 11. The backlight device 13 is an external light source for supplying light to the liquid crystal panel 11.

The touchscreen device 12 is placed on a front surface of the liquid crystal panel 11 (on a display surface 11a side) via an adhesive layer, which is not illustrated, and integrated to the liquid crystal panel 11. The touchscreen device 12 includes a panel body 20 having a plate shape and a cover panel (a protective panel, a cover glass) 14 placed on a front surface of the panel body 20, which will be described later.

The liquid crystal display device 10 further includes the liquid crystal panel 11 to which other components are integrated and a case 15 holding the liquid crystal panel 11 and the backlight device 13 therein. The case 15 is made of synthetic resin. The case 15 has a substantially box shape. The case 15 includes an opening on the front side, a bottom portion, and a peripheral portion that curves and rises from the bottom portion. The liquid crystal display device 10 according to this embodiment may be used for an electronic device such as a smartphone. The liquid crystal panel 11 and the touchscreen device 12 may be categorized as a small size with screen sizes of some inches.

The liquid crystal panel 11 includes a pair of substantially transparent glass substrates having a vertically long substantially rectangular shape in a plan view. The substrates are bonded together with a predefined gap therebetween (a cell gap). Liquid crystals are sealed between the substrates. One of the substrates on the rear side is an array substrate including source lines and gate lines that are perpendicular to one another, switching component connected to the source and the gate lines (e.g., TFTs), pixel electrodes connected to the switching components, and an alignment film. The substrate on the front side is a CF substrate including color filters that include red (R), green (G), and blue (B) color portions in predefined arrangements, a counter electrode, and an alignment film. Polarizing plates are attached to outer surfaces of the substrates, respectively.

The liquid crystal panel 11 is driven using an active matrix technology. Images are displayed on the display surface 11a using light supplied by the backlight device 13. Objects including textual information, icons, and pictograms for prompting a user to perform touching operations are displayed as appropriate on the display surface 11a. The display surface 11a has an outline similar to that of a touch surface R of the touchscreen device 12, which will be described later.

The backlight device 13 is a so-called edge light type (a side light type). The backlight device 13 is disposed behind the liquid crystal panel 11. The backlight device 13 includes LEDs as light sources for emitting light toward the backside of the liquid crystal panel 11.

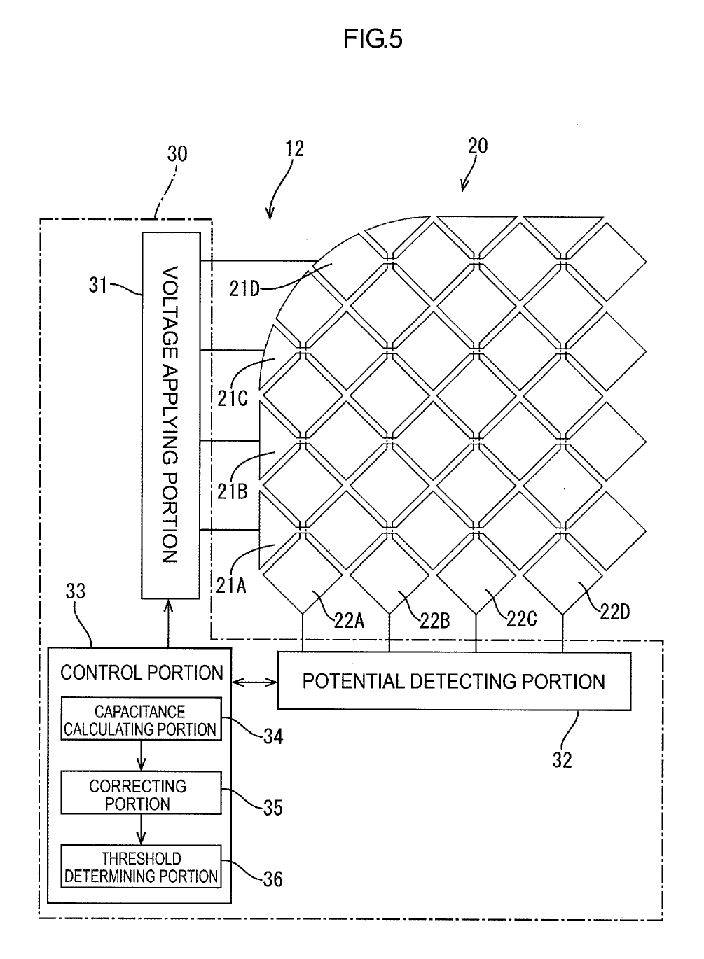

The touchscreen device 12 includes the panel body 20 and the cover panel 14, as described earlier. The touchscreen device 12 further includes a position detector 30 for detecting positions at which an operating object such as a fingertip of the user touches or approaches the touch surface R (touching positions) (see FIG. 5).

The cover panel 14 has a function to protect the panel body 20. As illustrated in FIG. 1, the cover panel 14 has a vertically long rectangular overall shape with round corners. The cover panel 14 may be a tempered glass in a plate shape. The cover panel 14 is substantially transparent and has high light transmissivity. The cover panel 14 is disposed in the case 15 to cover the liquid crystal panel 11 and the panel body 20.

In this embodiment, a portion of a front plate surface 14a of the cover panel 14 is the touch surface R that receives the touching operations performed with the fingertip of the user or other operating objects. The touch surface R corresponds to an area in which the touching operations with the fingertips or other operating objects can be performed and touching positions can be detectable with the sensors and the position detector 30, which will be described later. As illustrated in FIG. 1, the touch surface R in this embodiment has a vertically long rectangular overall shape with round corners on one of short sides. An end portion of the cover panel 14 on the short side includes a round cutout 14b. The cutout 14b is provided outside the touch surface R for arranging a pressing operation portion called a “home button.”

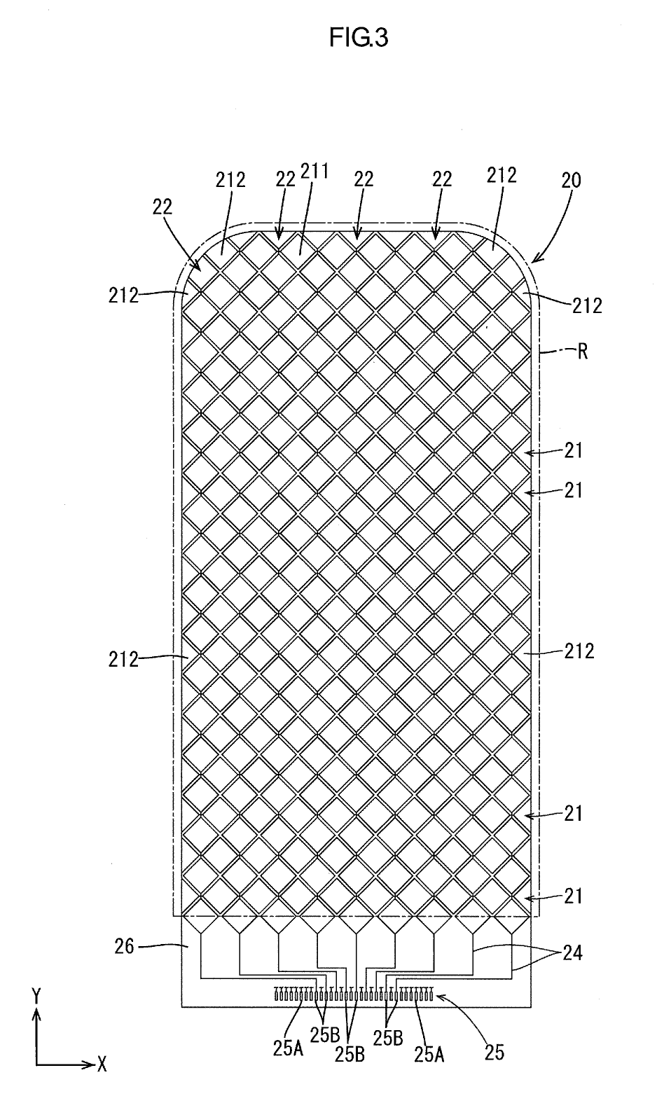

As illustrated in FIG. 3, the panel body 20 has a vertically long rectangular overall shape with round corners on one of short sides. The panel body 20 includes a transparent supporting base member 26 having a sheet shape. First electrodes 21, second electrodes 22, first lines 23, second lines 24, and a terminal portion 25 (first terminals 25A, second terminals 25B) are formed on the supporting base member 26.

The supporting base member 26 is a transparent plastic base member made of polyethylene terephthalate (PET) having a sheet shape. The supporting base member 26 has a vertically long rectangular overall shape with round corners on one of short sides. The first electrodes 21 and the second electrodes 22 are arranged on one of surfaces of the supporting base member 26 (on the front surface in this embodiment).

The first electrodes 21 are transmitting electrodes. The first electrodes 21 extend along the X-axis direction (a first direction). The first electrodes 21 are arranged parallel to one another on the supporting base member 26. The first electrodes 21 made from a transparent conductive film such as an indium tin oxide (ITO) film. The first electrodes 21 include lines of unit electrodes (first unit electrodes) 210 having island shapes and connected to one another via first links 213 having a linear shape. Two kinds of the unit electrodes (the first unit electrodes) 210 are provided. The unit electrodes 210 include a large number of regular unit electrodes (first regular unit electrodes) 211 having the same shape and irregular unit electrodes (first irregular unit electrodes) 212 shaped along the outline of the touch surface R.

The regular unit electrodes (the first regular unit electrodes) 211 have a diamond shape. The regular unit electrodes 211 included in the first electrodes 21 have the same size. The adjacent regular unit electrodes 211 of the first electrodes 21 are arranged such that corners thereof are opposed to each other and connected via the first links 213. The irregular unit electrodes (the first irregular unit electrodes) 212 are smaller than the regular unit electrodes 211. Each of the irregular unit electrodes has a shape as if a portion of the regular unit electrode 211 is cut off. The irregular unit electrodes 212 are mainly arranged in the outer edge portion of the touch surface R closer to an end of the first electrodes 21.

The second electrodes 22 are receiving electrodes. The second electrodes 22 extend along the Y-axis direction (a second direction perpendicular to the first direction). The second electrodes 22 are arranged parallel to one another on the supporting base member 26. The second electrodes 22 are made from a transparent conductive film similar to the first electrodes 21. The second electrodes 22 include lines of unit electrodes (second unit electrodes) 220 having island shapes and connected to one another via second links 223 having a linear shape. Two kinds of the unit electrodes (the second unit electrodes) 220 are provided. The unit electrodes 220 include a large number of regular unit electrodes (second regular unit electrodes) 221 having the same shape and irregular unit electrodes (second irregular unit electrodes) 222 shaped along the outline of the touch surface R. Basic configurations of the regular unit electrodes 221 and the irregular unit electrodes 222 including the shapes and the sizes similar to those of the first electrodes 21 and thus will not be described.

The first electrodes 21 and the second electrodes 22 are formed on the supporting base member 26 to cross one another while being insulated from one another such that the first links 213 and the second links 223 overlap one another (with insulation) and the unit electrodes (the first unit electrodes) 210 and the unit electrodes (the second unit electrodes) 220 do not overlap one another. A specific capacitance (a mutual capacitance) is formed at each intersection of each line of the first electrode 21 and the corresponding line of the second electrode 22 (i.e., a point at which each first link 213 overlaps the corresponding second link 223). Intersections are arranged in a matrix on aback of the touch surface R.

The terminal portion 25 is densely formed in a short edge portion of the supporting base member 26 which does not include the round corners (hereinafter referred to as a terminal portion-side edge portion). The terminal portion 25 includes the first terminals 25A connected to ends of the first lines 23 and the second terminals 25B connected to ends of the second lines 24.

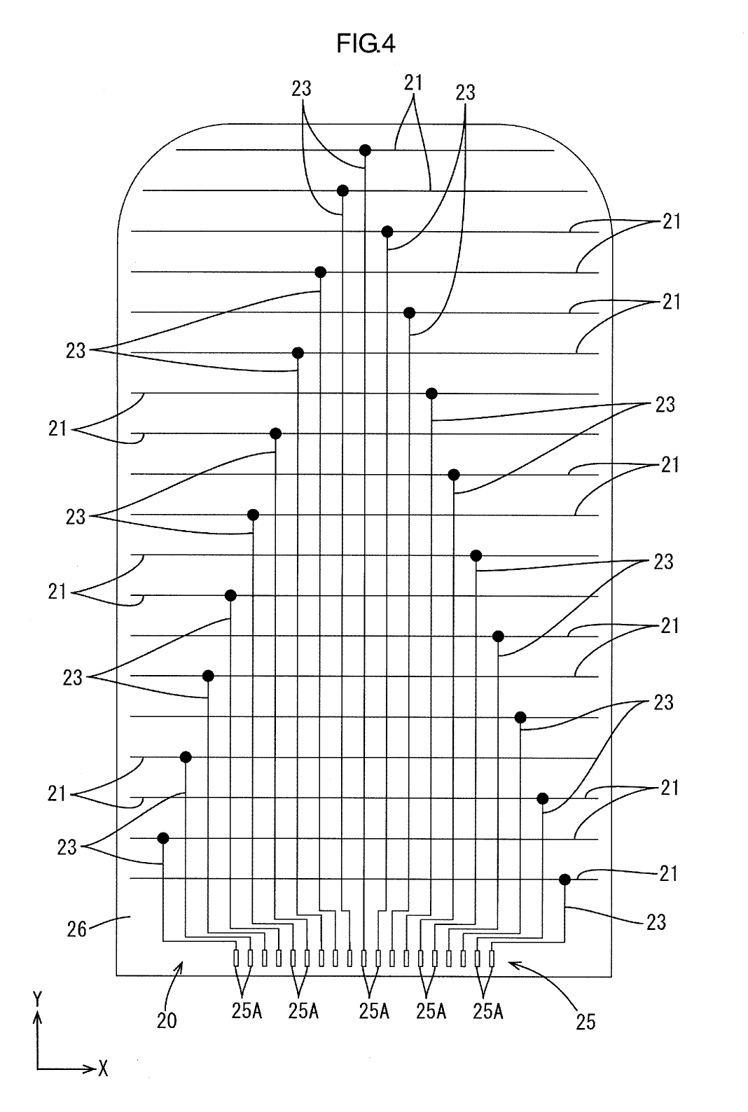

The first lines 23 are traces formed from transparent conductive film and connected to the first electrodes 21. As in the schematic diagram illustrated in FIG. 4, the first lines 23 are connected to the first electrodes 21, respectively. Although not illustrated in FIG. 3 or other drawings, the first lines 23 pass through spaces among the first electrodes 21 and the second electrodes 22 in zigzag shapes. The second lines 24 are traces formed from a transparent conductive film and connected to the second electrodes 22. The second lines 24 are connected to the second electrodes 22, respectively. The second lines 24 are connected to the unit electrodes 220 at the closest to the terminal portion-side edge portion).

The position detector 30 is electrically connected to the panel body 20 via a flexible circuit board, which is not illustrated. The position detector 30 detects mutual capacitances (capacitances) at the respective intersections of the first electrodes 21 and the respective second electrodes 22. The mutual capacitances decrease when the operating object such as a fingertip of the user touches or approaches the touch surface R. By comparing a detected mutual capacitance (a detected capacitance) at the corresponding intersection with a threshold, a position on the touch surface R at which a touching operation is performed (the intersection of the corresponding line of the first electrodes 21 and the corresponding line of the second electrodes 22) can be specified. Electrode pairs S are formed around the intersections of the first electrodes 21 and the second electrodes 22. As described later, the mutual capacitances (the capacitances) among the specific first electrodes 21 and the respective second electrodes 22 are compared with the threshold after corrected by the correcting portion 35.

The position detector 30 mainly includes a voltage applying portion 31, a potential detecting portion (an output detecting portion) 32, and a control portion 33.

The voltage applying portion 31 is electrically connected to one end of each first electrode 21. The voltage applying portion 31 applies driving voltages to the first electrodes 21 in a chronological sequence. The voltage applying portion 31 applies the driving voltages to the first electrodes 21 based on instructions from the control portion 33. The potential detecting portion 32 is electrically connected to an end of each second electrode 22. The potential detecting portion 32 detects information on potentials at the second electrodes output in response to the applied driving voltages. The second electrodes 22 are set to a ground potential. Results of the detection by the potential detecting portion 32 are transmitted to the control portion 33 as appropriate.

If a voltage (a driving voltage) is applied to one of the first electrodes 21 by the voltage applying portion 31 and potentials at all of the second electrodes 22 are detected by the potential detecting portion 32, capacitances at the intersections among the first electrodes 21 and all of the second electrodes 22 can be obtained. By sequentially applying the driving voltages to the first electrodes 21 and detecting the potentials of the second electrodes, the capacitances at all of the intersections of the first electrodes 21 and the second electrodes 22 are obtained.

The control portion 33 includes a capacitance calculating portion 34, a correcting portion 35, and a threshold determining portion (a specifying portion) 36. The control portion 33 may include a CPU, a ROM, and a RAM.

The capacitance calculating portion 34 calculates capacitances at the intersections of the first electrodes 21 and the second electrodes 22 based on the driving voltages applied to the first electrodes 21 by the voltage applying portion 31 and the potentials detected by the potential detecting portion 32.

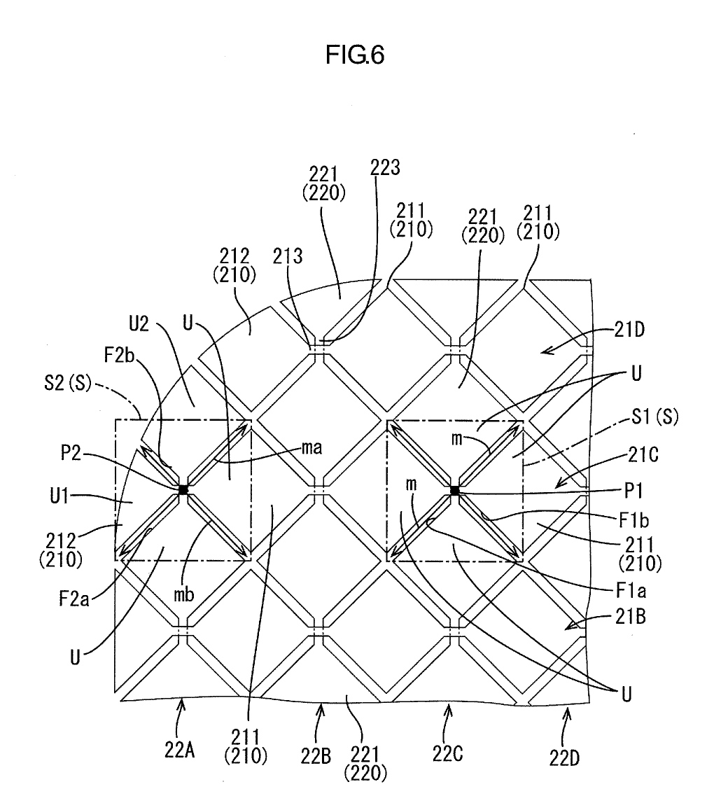

The capacitance at each intersection of the first electrodes 21 and the second electrodes 22 varies according to shapes of the first electrodes 21 and the second electrodes that surround the intersection. In FIGS. 5 and 6, four first electrodes are indicated with 21A, 21B, 21C, and 21D and four second electrodes are indicated with 22A, 22B, 22C, and 22D for the purpose of illustration. As illustrated in FIG. 6, the intersection P1 of the first electrodes 21C and the second electrodes 22C is surrounded by two regular unit electrodes 211 of the first electrodes 21C and two regular unit electrodes 221 of the second electrodes 22C. At the intersection P1, half portions of the regular unit electrodes 211 and 221 closer to the intersection P1 (regular sensor units U) mainly contribute to formation of the capacitance at the intersection P1. The intersections each surrounded by four regular sensor units U such as the intersection P1 are referred to as regular sensors S1. The regular sensors S1 correspond to regular electrode pairs according to the present invention. Many intersections defined by the first electrodes 21 and the second electrodes 22 (electrode pairs S) are referred to as regular sensors.

As illustrated in FIG. 6, an intersection P2 of the first electrode 21C and the second electrode 22A is surrounded by the regular unit electrode 211 and the irregular unit electrode 212 of the first electrode 21C and the regular unit electrode 221 and the irregular unit electrode 222 of the second electrode 22A. Two regular sensor units U and two small sensor units U1 and U2 that are smaller than the regular sensor units U are arranged around the intersection P2. One of the small sensor units U1 is included in the irregular unit electrode 212 of the first electrode 21C and the other small sensor unit U2 is included in the irregular unit electrode 222 of the second electrode 22A. The capacitance at the intersection P2 is smaller than the capacitance at the regular sensor S1. The intersections surrounded by the small sensor units U2 such as the intersection P2 are referred to as an irregular sensor S2. The irregular sensor S2 corresponds to an irregular electrode pair according to the present invention.

As described above, the capacitance at the irregular sensor S2 is smaller the capacitance at the regular sensor S1. The capacitance at the intersection corresponding to the irregular sensor S2 cannot be handled in the same manner as the capacitance at the regular sensor S1. Therefore, the correcting portion 35 amplifies an output from the irregular sensor S2 to the same level as an output from the regular sensor S1 in a correcting process.

The correcting portion 35 corrects the capacitances at the intersection corresponding to the irregular sensor S2 among the capacitances at the intersections calculated by the capacitance calculating portion 34 using a correction factor defined for the irregular sensor S2 in advance in the correcting process. The correction factor is stored in a memory such as a ROM in advance. The correction factor will be described below.

In regular sensor S1, the first electrode 21 and the second electrode 22 include portions opposed to each other with a gap. In the irregular sensor S2, the first electrode 21 and the second electrode 22 include portions opposed to each other with a gap. The correction factor is calculated based on a relationship (a ratio) between a length L1 of the opposed portions of the regular sensors S1 and a length L2 of the opposed portions of the irregular sensors S2.

In the regular sensor S1, the length L1 of the portions F1a and F1b of the first electrode 21 and the second electrode 22 opposed to each other is defined as 2m (=m+m). In the irregular sensor S2, the length L2 of the portions F2a and F2b of the first electrode 21 and the second electrodes 22 opposed to each other is defined as ma+mb (ma, mb<m, and mb<ma). The capacitances formed at the intersections of the first electrode 21 and the second electrodes 22 are substantially proportional to the length of the opposed portions of the first electrodes 21 and the adjacent second electrodes 22 in the respective sensors (the electrode pairs) S. Therefore, the correction factor in such an irregular sensor S2 is calculated from a formula:

L1/L2=2m/(ma+mb).

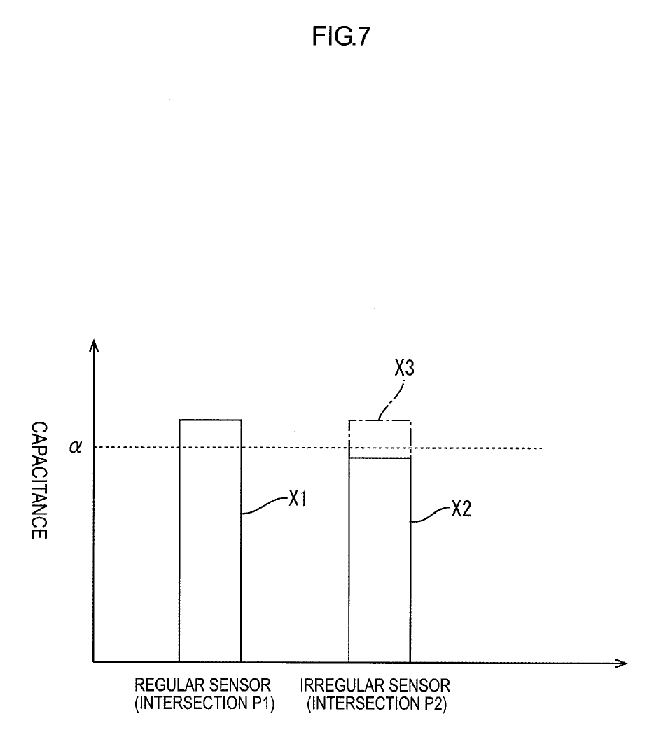

A relationship between the capacitance in the regular sensor S1 and the capacitance in the irregular sensor S2 after corrected is illustrated in FIG. 7. In FIG. 7, a bar graph indicated with X1 illustrates the capacitance in the regular sensor S1, a bar graph indicated with X2 illustrates a capacitance in the irregular sensor S2 before corrected (a measured capacitance), and a bar graph indicated with X3 illustrates the capacitance in the irregular sensor S2 after corrected (a corrected capacitance). As illustrated in FIG. 7, when the operating object such as a fingertip is not in touch with the touch surface R, a capacitance X2 in the irregular sensor S2 calculated by the capacitance calculating portion 34 is smaller than a capacitance X1 in the regular sensor S1. If the correcting process is performed for the capacitance X2 using the correction factor L1/L2 (e.g., multiplying the capacitance in the irregular sensor S2 by the correction factor L1/L2), the capacitance in the irregular sensor S2 at the same level as the capacitance in the regular sensor S1 is obtained as illustrated with X3. Namely, a difference in capacitance between the irregular sensor S2 and the regular sensor S1 (a difference in output intensity) is corrected.

The correction factors are calculated for multiple irregular sensors S2 defined by the first electrodes 21 and the second electrodes 22 in the same manner, respectively. The correction factors are stored in the memory.

After the correcting process is performed by the correcting portion 35, the capacitance at the regular sensor S1 calculated by the capacitance calculating portion 34 and the capacitance at the irregular sensor S2 corrected by the correcting portion 35 are compared with the predefined threshold a to determine whether the capacitances are lower than the threshold α. When the fingertip of the user approaches the touch surface R, the capacitance at the intersection in a portion corresponding to the position of the fingertip (the intersection of the first electrode 21 and the second electrode 22, i.e., the electrode pair S) varies (decreases in this embodiment). Namely, when the capacitance determined by the capacitance calculating portion 34 (or the corrected capacitance) is smaller than the threshold α, it is determined that the fingertip of the user is approaching the intersection.

If the threshold determining portion 36 determines that the capacitance at the intersection of the first electrode 21 and the second electrode (or the corrected capacitance) is smaller than the threshold α, the threshold determining portion 36 determines that the position of the intersection (the electrode pair S) and outputs information on the position to the outside. A specific image (a display object) is displayed on the display surface 11a of the liquid crystal display device 10.

As described above, the touchscreen device 12 according to this embodiment includes the correcting portion 35 for correcting the capacitance in the irregular sensor S2 arranged in an edge portion of the touch surface R. Therefore, the difference in signal intensity between the irregular sensor S2 and the regular sensor S1 is corrected. According to the configuration, a decrease in detecting sensitivity in the edge portion of the touch surface R is less likely to occur.

### Second Embodiment

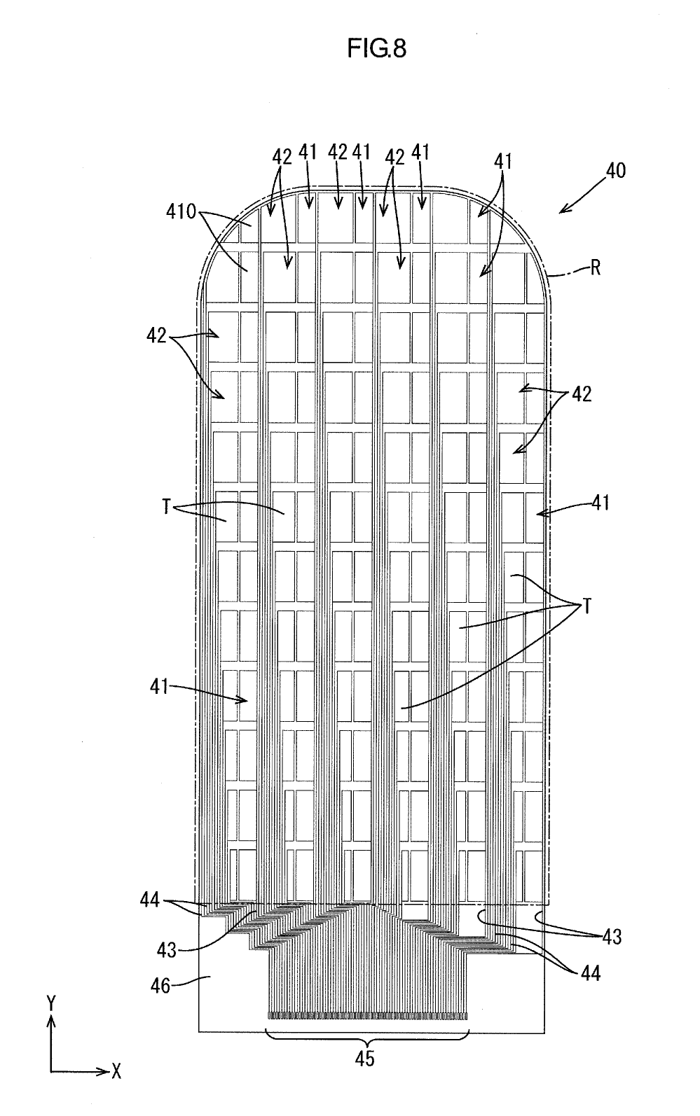

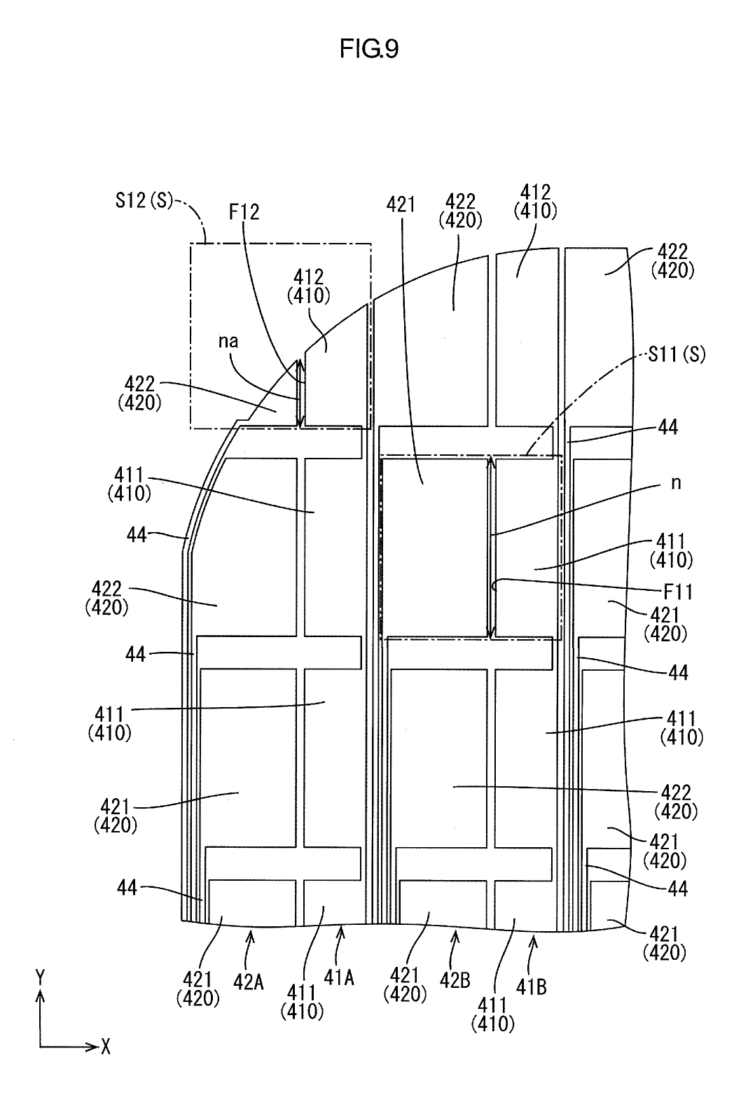

A second embodiment according to the present invention will be described with reference to FIGS. 8 and 9. A touchscreen device according to this embodiment includes a panel body 40 that is different from the first embodiment. Configurations of the second embodiment other than the panel body 40 are basically the same as the first embodiment and will not be described in detail. The panel body 40 in this embodiment includes electrode pairs having shapes different from the first embodiment.

As illustrated in FIG. 8, the panel body 40 has a vertically long rectangular overall shape with round corners on one of short sides, similar to the first embodiment. The panel body 40 includes lines of third electrodes 41, lines of fourth electrodes 42, third lines 43, fourth lines 44, and terminals 45 formed on a transparent supporting substrate 46 having a sheet shape.

The lines of third electrodes 41 and the lines of fourth electrodes 42 extend along the Y-axis direction (the first direction) and are alternately arranged along the X-axis direction (the second direction perpendicular to the first direction) on the supporting substrate 4. Each line of third electrodes 41 and the corresponding line of fourth electrodes 42 adjacent to each other are opposed to each other with a gap therebetween. The third electrodes 41 and the fourth electrodes 42 are made from transparent conductive films similar to the electrodes of the first embodiment and formed in the same layer as the supporting substrate 46.

The lines of third electrodes 41 each include unit electrodes (third unit electrodes) 410 in an island shape. The unit electrodes 410 are arranged in line along the Y-axis direction and connected via third links 413 in a linear shape. Namely, the unit electrodes (the third unit electrodes) 410 included in the third electrodes 41 are electrically connected to one another. The unit electrodes 410 of the first electrodes 41 include regular unit electrodes (third regular unit electrodes) 411 and irregular unit electrodes (third irregular unit electrodes) 412.

Each of the regular unit electrodes 411 of the third electrodes 41 has a vertically long rectangular shape. The rectangular unit electrodes 411 are arranged with short sides thereof along the X-axis direction and long sides thereof along the Y-axis direction. The irregular unit electrodes 412 of the third electrodes 41 have shapes as if the rectangular regular unit electrodes 411 are shaped along (or corresponding with) an outline of a touch surface R and smaller than the regular unit electrodes 411.

The fourth electrodes 42 include lines of electrodes T. The lines of electrodes T include unit electrodes (fourth unit electrodes) 420 having an island shape. The unit electrodes 420 are arranged in lines along the Y-axis direction. The unit electrodes (the fourth unit electrodes) 420 are separated from one another and electrically independent from one another. The unit electrodes 420 of the fourth electrodes 42 include regular unit electrodes (fourth regular unit electrodes) 421 and irregular unit electrodes (fourth irregular unit electrodes) 422.

Each of the regular unit electrodes 421 of the fourth electrodes 42 has a vertically long rectangular shape. The rectangular unit electrodes 421 are arranged with short sides thereof along the X-axis direction and long sides thereof along the Y-axis direction. The irregular unit electrodes 422 of the fourth electrodes 42 have shapes as if the rectangular regular unit electrodes 421 are shaped along (or corresponding with) the outline of the touch surface R and smaller than the regular unit electrodes 421.

Each of the unit electrodes (the third unit electrodes) 410 of the third electrodes 41 and the corresponding unit electrode (the fourth unit electrode) 420 of the fourth electrodes 42 adjacent to each other include portions opposed to each other with a gap such that sides thereof are opposed to each other. The opposed unit electrodes 410 and 420 are configured as one sensor. Namely, a capacitance (a mutual capacitance) is formed between each of the unit electrodes 410 of the third electrodes 41 and the corresponding one of the unit electrodes 420 of the fourth electrodes 42. Touching operations on the touch surface R are detected based on variations in capacitance.

The third lines 43 are traces formed from a transparent conductive film and connected to the third electrodes. As illustrated in FIG. 8, the third lines 43 are connected to ends of the third electrodes 41, respectively. The fourth lines 44 are connected to the unit electrodes 420 of the fourth electrodes 42, respectively. The second lines 44 are also traces formed from a transparent conductive film. Ends of the third lines 43 and the fourth lines 44 are connected to the terminals 45. The terminals 45 are collectively arranged in an end portion of the supporting substrate 46 close to one of short edges without the round corners.

In this embodiment, the capacitances formed at the sensors differ from one another according to the shapes of the third electrodes 41 and the fourth electrodes 42. For the purpose of illustration, two lines of third electrodes 41A and 41B and two lines of fourth electrodes 42A and 42B are illustrated in FIG. 9. For example, a regular sensor S11 includes the regular unit electrode 411 of the line of third electrodes 41B and the regular unit electrode 421 of the line of fourth electrodes 42B. Each of sides of the regular unit electrodes 411 and the regular unit electrode 421 adjacent and opposed to each other has a length L1 (a length of opposed portions F11) of n.

Irregular sensors S12 include the irregular unit electrodes 412 of the line of third electrode 41A and the irregular unit electrodes 422 of the line of fourth electrode 42A. A capacitance formed in the irregular sensor S12 is smaller than the capacitance in the regular sensor S11. Each of sides of the irregular unit electrodes 412 and the irregular unit electrode 422 adjacent and opposed to each other has a length L2 (a length of oppose portions F12) of na (<n).

The capacitances at the irregular sensors S12 are corrected by the correction portion 35 (see FIG. 5), similar to the first embodiment.

A correction factor in this embodiment is calculated based on a relationship (a ratio) between the length of the sides of the third electrode 41 (the regular unit electrode 411) and the fourth electrode 42 (the regular unit electrode 421) adjacent to each other in the regular sensor and the length of the sides of the third electrode 41 and the fourth electrode 42 in the irregular sensor S12.

For example, in the regular sensor S1, the length of the sides of the adjacent third and fourth electrodes 41 and 42 is n. In the irregular sensor S2, the length of the sides of the adjacent third and fourth electrodes 41 and 42 is na. The capacitance formed at each sensor (an electrode pair) S of the third electrodes 41 and the fourth electrodes 42 is substantially proportional to the length of the third electrode 41 and the fourth electrode 42 adjacent to each other in the sensor S. Therefore, the correction factor in the irregular sensor S12 can be calculated from a formula:

L1/L2=n/na.

With the correction factor, the capacitance at the irregular sensor S12 is corrected (e.g., multiplying the capacitance at the irregular sensor S12 by the correction factor). According to the configuration, a difference in capacitance (a difference in output intensity) between the correction sensor S12 and the regular sensor S11 is corrected.

As described above, in the touchscreen device according to this embodiment, the capacitance at the irregular sensor arranged in an edge portion of the touch surface R is corrected by the correcting portion 35. Therefore, a difference in signal intensity between the irregular sensor S12 and the regular sensor S11 is corrected. According to the configuration, a decrease in detecting sensitivity in the edge area of the touch surface R is less likely to occur.

### Other Embodiments

The present invention is not limited to the embodiments, which have been described using the foregoing descriptions and the drawings. For example, embodiments described below are also included in the technical scope of the present invention.

(1) In each of the above embodiments, the electrodes and the lines are made from the transparent conductive films. However, the scope of the present invention is not limited to those. For example, a light blocking conductive material such as a metal material may be used. In this case, the electrodes and the lines made of the light blocking conductive material may be in mesh forms so the touchscreen device has a sufficient amount of transmitting light. The light blocking conductive material may include carbon nanotube, graphene, and silver nanoparticles. A conductive polymer may be used for the electrodes and the lines.

(2) The traces of the electrodes and the lines may be formed in patterns different from those of the above embodiments.

(3) Each of the above embodiments includes the liquid crystal panel as a display panel. However, an organic EL panel or other known display panels may be used.

(4) In the first embodiment, the first regular electrodes and the second regular electrodes have the diamond shapes. However, they may have other shapes.

(5) In the second embodiment, the third regular unit electrodes and the fourth regular unit electrodes have the vertically long rectangular shapes. However, they may have other shapes.

### EXPLANATION OF SYMBOLS

10: liquid crystal display device, 11: liquid crystal panel (display panel), 11a: display surface, 12: touchscreen device, 13: backlight device, 14: cover panel, 15: case, 20: panel body, 30: position detector, 31: voltage applying portion, 32: potential detecting portion (output detecting portion), 33: control portion, 34: capacitance calculating portion, 35: correcting portion, 36: threshold determining portion (specifying portion), R: touch surface, S: sensor portion (electrode pair), S1, S11: regular sensor (regular electrode pair), S2, S12: irregular sensor (irregular electrode pair)

1. A touchscreen device comprising:
a touch surface that an operating object such as a fingertip touches or approaches;
electrode pairs arranged in a matrix behind the touch surface including electrodes opposed to one another with gaps to form capacitances that vary at least when the operating object touches portions of the touch surface corresponding to the electrode pairs, the electrode pairs including:
a regular electrode pair including opposed portions having a specified length; and
an irregular electrode pair including opposed portions having a length smaller than the length of the opposed portions of the regular electrode pair, the irregular electrode pair forming a capacitance smaller than a capacitance formed in the regular electrode pair;
a voltage applying portion for applying a driving voltage to the electrode pairs;
an output detecting portion for detecting outputs from the electrode pairs in response to the driving voltage;
a correcting portion for correcting an output from the irregular electrode pair among the outputs from the electrode pairs to amplify the output from the irregular electrode pair to a same level as the output from the regular electrode pair; and
a specifying portion for specifying the electrode pair having the capacitance that is defined as varied based on the output from the regular electrode pair and the output from the irregular electrode pair.

2. The touchscreen device according to claim 1, wherein the irregular electrode pair has a shape along an outline of the touch surface and is arranged along the outline of the touch surface being corrected.

3. The touchscreen device according to claim 1, wherein the correcting portion corrects the output from the irregular electrode pair using a ratio between the length L1 of the opposed portions of the regular electrode pair and the length L2 of the opposed portion of the irregular electrode pair.

4. The touchscreen device according to claim 3, wherein the correcting portion multiplies the output from the irregular electrode pair by a correction factor of L1/L2.

5. The touchscreen device according to claim 1, further comprising:
a plurality of first electrodes including lines of first unit electrodes having an island shape, the first unit electrodes in each line being linearly arranged and connected via first links, the lines of first unit electrodes being arranged parallel to each other; and
a plurality of second electrodes including lines of second unit electrodes having an island shape, the second unit electrodes in each line being linearly arranged and connected via second links, the lines of second unit electrodes being arranged parallel to each other, the line of second unit electrodes being arranged such that the second unit electrodes do not overlap the first unit electrodes and the second links cross the first links with gaps, wherein
the electrode pairs are formed at intersections of the first electrodes and the second electrodes, respectively.

6. The touchscreen device according to claim 5, wherein
the first unit electrodes include first regular unit electrodes having a regular shape and first irregular unit electrodes having shapes as if portions of the first regular unit electrodes are cut off,
the second unit electrodes include second regular unit electrodes having a regular shape and second irregular unit electrodes having irregular shapes as if portions of the second regular unit electrodes are cut off,
the regular electrode pair include the first regular unit electrodes and the second regular unit electrodes, and
the irregular electrode pair include the first irregular unit electrodes and the second irregular unit electrodes.

7. The touchscreen device according to claim 6, wherein the first regular unit electrodes and the second regular unit electrodes have diamond shapes.

8. The touchscreen device according to claim 1, further comprising:
a plurality of third electrodes including lines of third unit electrodes having an island shape, the third unit electrodes in each line being linearly arranged and connected via third links, the lines of third unit electrodes being arranged parallel to each other; and
a plurality of fourth electrodes including fourth unit electrodes having an island shape and arranged in lines with gaps, lines of the fourth unit electrodes being arranged parallel to the third electrodes such that each of the fourth unit electrodes is opposed to the corresponding third unit electrode with a gap, wherein
the electrode pairs include portions of the third unit electrodes and the fourth unit electrodes opposed to one another.
